(19) United States
(12) Patent Application Publication
(10) Pub. No.: US 2023/0339321 A1
(43) Pub. Date: Oct. 26, 2023

(54) System and Method for the Interactive Control of Vehicle Functions

(71) Applicant: Bayerische Motoren Werke Aktiengesellschaft, Muenchen (DE)

(72) Inventors: Stefan DIEWALD, Moosburg a. d. Isar (DE); Bernhard GASSER, Muenchen (DE)

(21) Appl. No.: 18/137,202

(22) Filed: Apr. 20, 2023

(30) Foreign Application Priority Data
Apr. 21, 2022 (DE) 10 2022 109 633.5

(51) Int. Cl. B60K 35/00; H04W 4/38; H04W 4/80

(52) U.S. Cl. CPC B60K 35/00; H04W 4/38; H04W 4/80; B60K 2370/5911; B60K 2370/56; B60K 2370/167

(57) ABSTRACT

A system comprises a vehicle and a smart device. The smart device is configured to establish a communicative connection with the vehicle. The vehicle is configured to determine a trigger event in the vehicle comprising an evaluation of sensor data in the vehicle. Upon the trigger event being determined by the vehicle, the vehicle is configured to communicate a trigger data set to the smart device. The smart device is configured, after receiving the trigger data set, to interact with the vehicle according to the trigger data set. The interacting of the smart device with the vehicle can comprise controlling at least one vehicle function of the vehicle.

### CROSS REFERENCE TO RELATED APPLICATION

This application claims priority under 35 U.S.C. § 119 from European Patent Application No. 102022109633.5, filed Apr. 21, 2022, the entire disclosure of which is herein expressly incorporated by reference.

### BACKGROUND AND SUMMARY

The present invention relates to a system and a method for the interactive control of vehicle functions.

Communicative connections between a vehicle and a smart device are known from the prior art. In that case, such a communicative connection can be effected in a wired or wireless manner in order for example to integrate telephony and music functions in the vehicle via the smart device. Furthermore, it is known to set up a communicative connection between vehicle and smart device by means of a backend. In that case, the vehicle can communicate a data set to the backend. There, a smart device linked to the vehicle can be determined and the—if appropriate correspondingly processed—data set can be communicated from the backend to the smart device. By way of example, for the vehicle user of an at least partly electrified vehicle, when a charging process is carried out at a charging device, at the end of the charging process or upon a charging target being fulfilled, a corresponding data set can be communicated from the vehicle to the linked smart device of the vehicle user via the backend. Moreover, it is possible, via the smart device, to communicate a control command to the vehicle via the backend, for example for the purpose of controlling the central locking, for the purpose of activating auxiliary heating, for the purpose of opening/closing a vehicle window, etc.

The problem addressed by the invention consists in providing a solution which enables a direct, adaptive interaction and control of vehicle functions via a smart device.

This problem is solved according to the invention by means of the features of the independent claims. The dependent claims relate to preferred embodiments.

The problem mentioned above is solved by means of a system for the interaction control of vehicle functions, comprising:

a vehicle;

a smart device, wherein the smart device is configured to establish or set up a communicative connection with the vehicle; and

wherein the vehicle is configured
to determine a trigger event in the vehicle, wherein determining the trigger event comprises the evaluation of sensor data in the vehicle;
to communicate a trigger data set to the smart device upon the trigger event being determined;

wherein the smart device is configured, after receiving the trigger data set, to interact with the vehicle according to the trigger data set.

The system comprises a vehicle and at least one smart device.

In the context of this document, the term smart device encompasses in particular modern portable computer systems, in particular smartphones, smartwatches, smartglasses, etc., which have a multiplicity of sensors that are able to acquire a wide variety of sensor data and to set up a communicative connection with a vehicle by means of a communication unit and—for example via Bluetooth Low Energy (BLE), the Internet or any other suitable air interface—in a wireless manner.

The smart device comprises a sensor unit configured to acquire sensor data. In particular, the sensor data can comprise movement data of the bearer of the smart device. For the purpose of acquiring the movement data, the sensor unit can in this case acquire sensor data from one or more of the following sensors:

an acceleration sensor or accelerometer, which ascertains an acceleration by measuring an inertia force acting on a mass or test mass, with the result that it can determine the acceleration, an increase or decrease in speed and/or a direction of movement of the smart device; and/or

a position determining sensor or a position determining unit for acquiring or determining the geographical position or current position data with the aid of a navigation satellite system. The navigation satellite system can be any conventional and future global navigation satellite system (GNSS) for position determination and navigation by reception of signals from navigation satellites and/or pseudolites. This can involve for example the Global Positioning System (GPS), GLObal NAvigation Satellite System (GLONASS), Galileo positioning system, and/or BeiDou Navigation Satellite System. In the example of GPS, the position determining sensor or the position determining unit can comprise a GPS module configured to determine current GPS position data of the smart device; and/or

a gyro sensor, which is an acceleration or position sensor, configured to sense tiny accelerations, rotational movements and/or changes in position of a mass or test mass. Data of the gyro sensor can be combined with position data of a navigation module, wherein changes in direction, for example, can be ascertained very accurately through the combination of gyro sensor data and position data; and/or

a magnetic field sensor configured to sense a current orientation or direction of movement of the smart device; and/or

a proximity sensor or approach sensor for activating or deactivating the display of the smart device; and/or

at least one further sensor configured to acquire movement data of the smart device.

The system comprises at least one vehicle. In the context of this document, the term vehicle encompasses mobile means of transport that serve to transport persons (passenger traffic), goods (freight traffic) or tools (machines or implements). In particular, the term vehicle encompasses motor vehicles and motor vehicles which can be driven electrically at least in part (electric automobile, hybrid vehicles).

The vehicle can be controlled by a vehicle driver. In addition or as an alternative thereto, the vehicle can be an at least partially automated driving vehicle. In the context of this document, the term “automated driving vehicle” or “automated driving” can be understood to mean driving with automated longitudinal or lateral control or autonomous driving with automated longitudinal and lateral control. Automated driving can involve for example driving for a relatively long time on the interstate or driving for a limited time in the context of parking or maneuvering. The term “automated driving” encompasses automated driving with an arbitrary degree of automation. Exemplary degrees of automation are assisted, partly automated, highly automated or fully automated driving. These degrees of automation were defined by the German Federal Highway Research Institute (BASt) (see BASt publication “Research compact”, issue November 2012). In the case of assisted driving, the driver permanently carries out the longitudinal or lateral control, while the system performs the respective other function within certain limits. In the case of partly automated driving, the system performs the longitudinal and lateral control for a certain period of time and/or in specific situations, wherein the driver must permanently monitor the system as in the case of assisted driving. In the case of highly automated driving, the system performs the longitudinal and lateral control for a certain period of time, without the driver having to permanently monitor the system. However, the driver must be able to take over control of the vehicle within a certain time. In the case of fully automated driving, the system can automatically manage driving in all situations for a specific application; a driver is no longer required for this application. The four degrees of automation mentioned above correspond to SAE levels 1 to 4 of the SAE J3016 standard (SAE—Society of Automotive Engineering). Furthermore, SAE J3016 also provides SAE level 5 as the highest degree of automation, which is not contained in the definition by the BASt. SAE level 5 corresponds to driverless driving, wherein the system can automatically manage all situations like a human driver during the entire journey.

The smart device is configured to establish a communicative connection with the vehicle or to couple to the vehicle in a manner known from the prior art. This can be done by means of Bluetooth Low Energy (BLE), for example, as explained in greater detail further below.

The vehicle can comprise a computing unit. The computing unit is configured to determine a trigger event in the vehicle. In this case, determining the trigger event comprises the evaluation of sensor data in the vehicle.

Upon the trigger event being determined, the computing unit is configured to communicate a trigger data set to the smart device via the communicative connection.

As a result of the trigger data set being communicated from the vehicle to the smart device via the communicative connection, the vehicle can call up a suitable, predeterminable or predetermined application or app in the smart device, which comprises a corresponding functionality. In another example, the functionality described below can already be integrated in the operating system of the smart device and can be correspondingly called up or activated by the communication of the trigger data set from the vehicle to the smart device.

The interacting of the smart device with the vehicle after receiving the trigger data set from the vehicle comprises at least one instance of feedback from the smart device to the vehicle indicating that an action according to the trigger data set has taken place. Furthermore, in the context of this document, the interacting of the smart device with the vehicle after receiving the trigger data set can comprise:

a reaction of the smart device according to the content of the received trigger data set; and/or

a control and/or interaction of the smart device by functions and/or devices connected to the smart device, wherein the devices can comprise for example smart home devices known to the smart device, as explained in greater detail further below; and/or

an interaction of the smart device with the bearer of the smart device in a manner known from the prior art, wherein the interacting with the bearer of the smart device comprises for example an output of the smart device, e.g. notification to the user via user interfaces of the smart device known from the prior art, for example a visual and/or acoustic and/or haptic, etc. notification and/or an input by the bearer of the smart device that is required for the further procedure, for example via touch input, voice input, etc.; and/or

a communication of further predeterminable or predetermined data for further interaction with the vehicle between smart device and vehicle.

This makes it possible to realize an interaction between vehicle and smart device in a very flexible manner, without intervention by the user of the vehicle and/or smart device being necessarily required. In particular, a computing unit of the smart device can process the trigger data set. Interacting of the smart device with the vehicle as explained above can be carried out on the basis of the processed data of the trigger data set.

Advantageously, a particularly agile and flexible interaction between the smart device, the vehicle, further devices connected to the smart device and/or the bearer of the smart device can thus be effected.

Preferably, the interacting of the smart device with the vehicle comprises controlling at least one vehicle function of the vehicle.

The interaction between the smart device and the vehicle can comprise in particular controlling at least one vehicle function of the vehicle. For this purpose, the vehicle can comprise a control unit configured to control or regulate a predefinable or predefined vehicle function according to the trigger event and/or the interaction between smart device and vehicle, as explained in greater detail further below with reference to FIG. 1.

Preferably, the vehicle and the smart device each comprise a communication unit, wherein the vehicle and the smart device are configured to set up a Bluetooth Low Energy (BLE) connection between one another.

BLE is a radio technology that enables communication between two communication subscribers in relatively close proximity, e.g. 10 m, 50 m, 100 m, 500 m, in a manner known from the prior art. This radio technology has a very low power consumption in comparison with traditional Bluetooth.

By way of example, the smart device can already be configured as a digital key or a digital vehicle key in a manner known from the prior art for the vehicle. By means of the BLE technology, it is thus possible for the bearer of the smart device, without any initial input or requirement of an initial connection between the vehicle and the smart device, by means of approaching the vehicle, to set up a communicative connection with the vehicle or to interact with the vehicle, wherein security with respect to the communication between the vehicle and the smart device is simultaneously ensured by the digital key security requirements. The digital key security requirements or security requirements of digital vehicle keys are known from the prior art, for example known in accordance with the Standard Car Connectivity Consortium®.

Preferably, the evaluating of sensor data in the vehicle for the purpose of determining the trigger event comprises determining a spatial relation between the smart device and the vehicle.

By way of example, the computing unit of the vehicle can be configured to determine a spatial relation between the smart device and the vehicle. In particular, the determined spatial relation between the smart device and the vehicle can be taken into account by the computing unit of the vehicle when determining the trigger event or can be a (partial) prerequisite for determining the trigger event.

For this purpose, communication between smart device and vehicle can be effected using ultra-wideband technology (UWB). This involves short-range radio communication that uses extremely large frequency ranges with a bandwidth of at least 500 MHz or of at least 20% of the arithmetic mean of the lower and upper limit frequencies of the frequency band used. Advantageously, a highly precise determination of the position of the smart device with respect to the vehicle can be achieved through the use of UWB technology. In this case, the data can be transmitted from the smart device to the vehicle locally via a suitable radio interface, e.g. Bluetooth Low Energy (BLE). The spatial relation can result from the highly precise determination of the position of the smart device or the bearer of the smart device with respect to the vehicle. In this case, the position of the smart device with respect to the vehicle can be implemented in zones depending on the system design. In this case, in the region of the exterior of the vehicle, for example, a rear zone, a front zone and side zones are conceivable. Furthermore, it is also possible to determine the spatial relation by means of a precise position of the smart device with respect to the vehicle, for example 1 meter (m) in front of the driver's door. Furthermore, the determination of the spatial relation can also comprise the identification of at least one movement vector of the smart device relative to the vehicle, whereby a movement of the user of the smart device relative to the vehicle can be determined. The determination of the spatial relation in the vehicle interior is also possible as a precise position in the vehicle interior. In another example, the vehicle interior can also be subdivided into zones, e.g. driver's seat, passenger seat, right back seat region, etc.

Exemplary embodiments are explained further below with reference to FIG. 1.

Advantageously, the agility and flexibility of the interaction between smart device and vehicle is thus increased since the vehicle can determine and take account of the exact position and/or a movement vector of the bearer of the smart device with respect to the vehicle. There is thus also an increase in the agility and flexibility during the control of the vehicle functions, the security—through the use of digital key standards—in the interaction between smart device and vehicle and thus in the control of the vehicle functions being ensured at the same time.

Preferably, the sensor data in the vehicle which are evaluated for determining the trigger event in the vehicle comprise:
a current geographical position of the vehicle; and/or
data concerning a Point of Interest, POI, according to a current geographical position of the vehicle; and/or
data with respect to a geographical position that is important for the user of the vehicle, e.g. a home address, a work address, etc.; and/or
a current time of day or a current time stamp; and/or
a current position and/or a current movement vector of the smart device relative to the vehicle; and/or
smart device sensor data that were acquired by the sensor unit of the smart device and transmitted to the vehicle via the communicative connection, wherein the smart device sensor data can be processed by the smart device before being transmitted to the vehicle;
a current state of a vehicle function or a current vehicle sensor value, wherein the vehicle function or the vehicle sensor value can comprise data with respect to the following vehicle functions or vehicle sensor values:
   light switched on or off; and/or
   doors right/left front/back or trunk or hood opened or closed; and/or
   current tire pressure of tires front/back right/left; and/or
   charging flap and/or gas cap opened/closed; and/or
   requisite need for maintenance in the vehicle; and/or
   state of charge or fuel tank level of the vehicle; and/or
   any further suitable current state of a vehicle function.

In this case, each trigger event can be predefined and/or be added in a flexible way. Furthermore or as an alternative thereto, a trigger event and also subsequent interactions between smart device and vehicle can be learned with the aid of suitable machine learning algorithms, for example with the aid of models created by machine learning methods—e.g. by means of supervised learning or unsupervised learning.

The predefined or predefinable sensor data mentioned above are presented merely by way of example; in principle, they can comprise any vehicle-related sensor data in any combination.

In accordance with a second aspect, the problem addressed is solved by means of a method for the interactive control of vehicle functions, comprising:

determining, by means of the vehicle, a trigger event in the vehicle, wherein determining the trigger event comprises an evaluation of sensor data in the vehicle; communicating, upon the trigger event being determined, a trigger data set to the smart device;

interacting of the smart device with the vehicle according to the trigger data set.

Preferably, the interacting of the smart device with the vehicle comprises controlling at least one vehicle function of the vehicle.

Preferably, the vehicle and the smart device each comprise a communication unit, wherein the communicative connection between vehicle and smart device comprises a Bluetooth Low Energy, BLE, connection.

Preferably, the evaluating of sensor data in the vehicle when determining the trigger event comprises determining a spatial relation between the smart device and the vehicle.

Preferably, the sensor data in the vehicle which are evaluated for determining the trigger event in the vehicle comprise:
a current geographical position of the vehicle; and/or
data concerning a Point of Interest, POI, according to a current geographical position of the vehicle; and/or
data with respect to a geographical position that is important for the user of the vehicle; and/or
a current time of day or a current time stamp; and/or
a current position and/or a current movement vector of the smart device relative to the vehicle; and/or
a current state of a vehicle function or a current vehicle sensor value, wherein the vehicle function or the vehicle sensor value can comprise data with respect to the following vehicle functions or vehicle sensor values:
   light switched on or off; and/or
   doors right/left front/back or trunk or hood opened or closed; and/or
   current tire pressure of tires front/back right/left; and/or
   charging flap and/or gas cap opened/closed; and/or
   requisite need for maintenance in the vehicle; and/or
   state of charge or fuel tank level of the vehicle; and/or
   any further suitable current state of a vehicle function or vehicle sensor value.

These and other problems addressed, features and advantages of the present invention are elucidated from study of the following detailed description of preferred embodiments and the accompanying figures. It is evident that—although embodiments are described separately—individual features therefrom can be combined to form additional embodiments.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a system for the interactive control of vehicle functions;

FIG. 2 shows one exemplary method for the interactive control of vehicle functions.

### DETAILED DESCRIPTION OF THE DRAWINGS

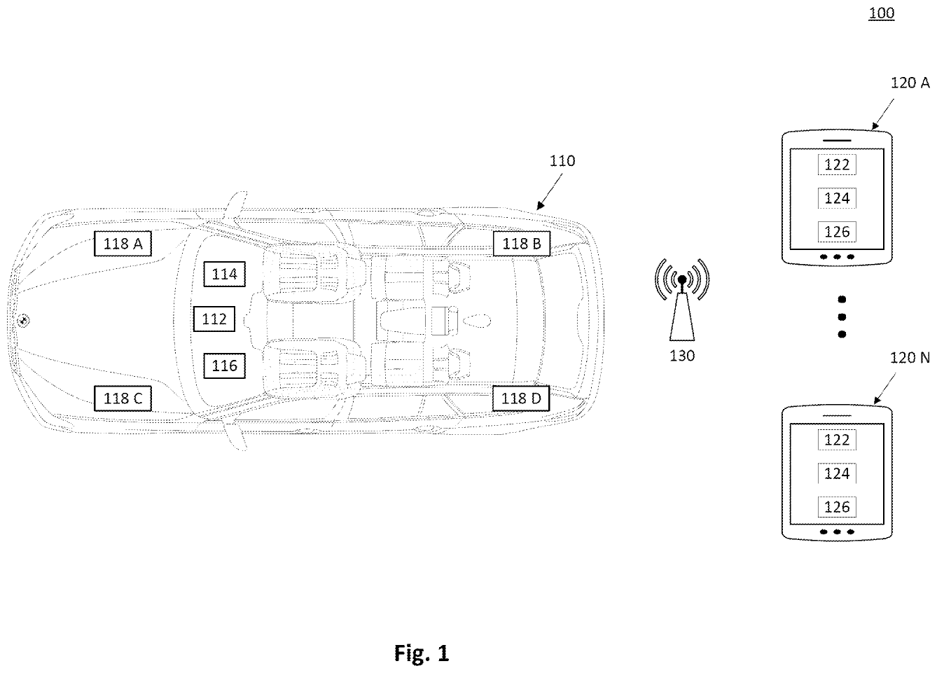

FIG. 1 schematically shows a system 100 for the interactive control of vehicle functions of a vehicle 110.

The system 100 comprises a vehicle 110 and at least one smart device 120 A . . . 120 N. The smart device 120 A . . . 120 N can comprise a sensor unit 124 configured to acquire sensor data. In particular, the sensor data can comprise movement data of a bearer of the smart device 120 A . . . 120 N. For acquiring the movement data, the sensor unit 124 can in this case acquire sensor data from one or more of the following sensors:

an acceleration sensor or accelerometer, which ascertains an acceleration by measuring an inertia force acting on a mass or test mass, with the result that it can determine the acceleration, an increase or decrease in speed and/or a direction of movement of the smart device (120 A . . . 120 N); and/or

a position determining sensor or a position determining unit for acquiring or determining the geographical position or current position data with the aid of a navigation satellite system. The navigation satellite system can be any conventional and future global navigation satellite system (GNSS) for position determination and navigation by reception of signals from navigation satellites and/or pseudolites. This can involve for example the Global Positioning System (GPS), GLObal NAvigation Satellite System (GLONASS), Galileo positioning system, and/or BeiDou Navigation Satellite System. In the example of GPS, the position determining sensor or the position determining unit can comprise a GPS module configured to determine current GPS position data of the smart device 120 A . . . 120 N; and/or

a gyro sensor, which is an acceleration or position sensor, configured to sense tiny accelerations, rotational movements and/or changes in position of a mass or test mass. Data of the gyro sensor can be combined with position data of a navigation module, wherein changes in direction, for example, can be ascertained very accurately through the combination of gyro sensor data and position data; and/or

a magnetic field sensor configured to sense a current orientation or direction of movement of the smart device 120 A . . . 120 N; and/or

a proximity sensor or approach sensor for activating or deactivating the display of the smart device 120 A . . . 120 N; and/or

at least one further sensor configured to acquire movement data of the smart device 120 A . . . 120 N.

The smart device 120 A . . . 120 N is configured to establish and/or set up a communicative connection with the vehicle 110.

The vehicle 110 and the smart device 120 A . . . 120 N can each comprise a communication unit 116, 126. The vehicle 110 and the smart device 120 A . . . 120 N can be configured to set up a Bluetooth Low Energy (BLE) connection to one another by means of the respective communication unit 116, 126 in a manner known from the prior art.

By way of example, the smart device 120 A . . . 120 N can already be configured as a digital key or a digital vehicle key in a manner known from the prior art for the vehicle 110. By means of the BLE technology, it is thus possible for the bearer of the smart device 120 A . . . 120 N, without any initial input or requirement of an initial connection between the vehicle 110 and the smart device 120 A . . . 120 N, by means of approaching the vehicle 110, to set up a communicative connection with the vehicle 110 or to interact with the vehicle 110, wherein security with respect to the communication between the vehicle 110 and the smart device 120 A . . . 120 N is simultaneously ensured by the digital key security requirements. The digital key security requirements or security requirements of digital vehicle keys are known from the prior art, for example known in accordance with the Standard Car Connectivity Consortium®.

The vehicle 110 is configured to determine a trigger event with respect to the vehicle. In this case, determining the trigger event comprises the evaluation of sensor data in the vehicle 110. The acquiring and evaluating of sensor data in the vehicle 110 are effected in a manner known from the prior art. The vehicle 110 can comprise a computing unit 112 configured to evaluate sensor data in the vehicle and—on the basis of predefinable or predefined criteria—to determine a trigger event.

The sensor data in the vehicle 110 which are evaluated for determining the trigger event in the vehicle can comprise:
a current geographical position of the vehicle 110; and/or
data concerning a Point of Interest, POI, according to a current geographical position of the vehicle 110; and/or
data with respect to a geographical position that is important for the user of the vehicle 110, e.g. a home address, a work address, etc.; and/or
a current time of day or a current time stamp; and/or
a current position and/or a current movement vector of the smart device 120 A . . . 120 N relative to the vehicle 110; and/or
smart device sensor data that were acquired by the sensor unit 124 of the smart device 120 A . . . 120 N and transmitted to the vehicle 110 via the communicative connection, wherein the smart device sensor data can be processed by the smart device 120 A . . . 120 N before being transmitted to the vehicle 110;
a current state of a vehicle function or a current vehicle sensor value, wherein the vehicle function or the vehicle sensor value can comprise data with respect to the following vehicle functions or vehicle sensor values:
   light switched on or off; and/or
   doors right/left front/back or trunk or hood opened or closed; and/or
   current tire pressure of tires front/back right/left; and/or
   charging flap and/or gas cap opened/closed; and/or
   requisite need for maintenance in the vehicle; and/or
   state of charge or fuel tank level of the vehicle; and/or
   any further suitable current state of a vehicle function.

Preferably, the evaluating of sensor data in the vehicle for the purpose of determining the trigger event comprises determining a spatial relation between the smart device and the vehicle.

The vehicle 110 or the computing unit 112 of the vehicle 110 can be configured to determine a spatial relation between the smart device 120 A . . . 120 N and the vehicle 110. In particular, the determined spatial relation between the smart device 120 A . . . 120 N and the vehicle 110 can be taken into account by the computing unit 112 of the vehicle 110 when determining the trigger event or can be a (partial) prerequisite for determining the trigger event.

In order to determine the spatial relation between the smart device 120 A . . . 120 N and the vehicle 110, communication between smart device 120 A . . . 120 N and vehicle 110 can be effected using ultra-wideband technology (UWB). This involves short-range radio communication that uses extremely large frequency ranges with a bandwidth of at least 500 MHz or of at least 20% of the arithmetic mean of the lower and upper limit frequencies of the frequency band used. Advantageously, a highly precise determination of the position of the smart device 120 A . . . 120 N with respect to the vehicle 110 can be achieved through the use of UWB technology. In this case, the data can be transmitted from the smart device 120 A . . . 120 N to the vehicle 110 locally via a suitable radio interface, or the abovementioned communicative connection 130, e.g. Bluetooth Low Energy (BLE), between smart device 120 A . . . 120 N and vehicle 110. The spatial relation can result from the highly precise determination of the position of the smart device 120 A . . . 120 N or the bearer of the smart device 120 A . . . 120 N with respect to the vehicle 110. For this purpose, the vehicle 110 can comprise UWB anchors 118 A . . . 118 D. In this case, the position of the smart device 120 A . . . 120 N with respect to the vehicle 110 can be implemented in zones depending on the system design. In this case, in the region of the exterior of the vehicle 110, for example, a rear zone, a front zone and side zones are conceivable. Furthermore, or as an alternative thereto, the determination of the spatial relation can also comprise the identification of at least one movement vector of the smart device 120 A . . . 120 N relative to the vehicle 110, whereby a movement of the user of the smart device 120 A . . . 120 N relative to the vehicle 110 can be determined. Furthermore, or as an alternative thereto, it is also possible to determine the spatial relation by means of a precise position of the smart device 120 A . . . 120 N with respect to the vehicle 110, for example 1 meter (m) in front of the driver's door. Furthermore, or as an alternative thereto, the determination of the spatial relation in the vehicle interior is possible as a precise position in the vehicle interior. In another example, the vehicle interior can also be subdivided into zones, e.g. driver's seat, passenger seat, right back seat region, etc.

Upon or as a consequence of the trigger event being determined, the vehicle 110 is configured to communicate a trigger data set to the smart device 120 A . . . 120 N—via the communicative connection 130. In this case, a predefined or predefinable trigger data set can be assigned to each trigger event.

After receiving the trigger data set from the vehicle 110, the smart device 120 A . . . 120 N is configured to interact with the vehicle 110 according to the trigger data set. In this case, a predetermined or predeterminable interaction between the vehicle 110 and the smart device 120 A . . . 120 N can be effected in respect of each trigger data set.

As a result of the trigger data set being communicated from the vehicle 110 to the smart device 120 A . . . 120 N via the communicative connection 130, the vehicle 110 can call up a suitable, predeterminable or predetermined application or app in the smart device 120 A . . . 120 N, which comprises a corresponding functionality. In another example, the functionality described below can already be integrated in the operating system of the smart device 120 A . . . 120 N and can be correspondingly called up or activated by the communication of the trigger data set from the vehicle 110 to the smart device 120 A . . . 120 N.

The interacting of the smart device 120 A . . . 120 N with the vehicle 110 after receiving the trigger data set from the vehicle comprises at least one instance of feedback from the smart device 120 A . . . 120 N to the vehicle 110 indicating that an action according to the trigger data set has taken place. Furthermore, in the context of this document, the interacting of the smart device 120 A . . . 120 N with the vehicle 110 after receiving the trigger data set can comprise:

a reaction of the smart device 120 A . . . 120 N according to the processed content of the received trigger data set; and/or

a control and/or interaction of the smart device 120 A . . . 120 N by functions and/or devices connected to the smart device 120 A . . . 120 N, wherein the devices can comprise for example smart home devices known to the smart device, as explained in greater detail further below; and/or

an interaction of the smart device 120 A . . . 120 N with the bearer of the smart device 120 A . . . 120 N in a manner known from the prior art, wherein the interacting with the bearer of the smart device 120 A . . . 120 N comprises for example an output of the smart device 120 A . . . 120 N, e.g. notification to the user via user interfaces of the smart device 120 A . . . 120 N known from the prior art, for example a visual and/or acoustic and/or haptic etc. notification and/or an input by the bearer of the smart device 120 A . . . 120 N that is required for the further procedure, for example via touch input, voice input, etc.; and/or

a communication of further predeterminable or predetermined data for further interaction with the vehicle 110 between smart device 120 A . . . 120 N and vehicle 110.

This makes it possible to realize an interaction between vehicle 110 and smart device 120 A . . . 120 N in a very flexible manner, without intervention by the user of the vehicle and/or smart device being necessarily required. In particular, a computing unit 122 of the smart device 120 A . . . 120 N can process the trigger data set. Interacting of the smart device 120 A . . . 120 N with the vehicle 110 as explained above can be carried out on the basis of the processed data of the trigger data set.

The interacting of the smart device 120 A . . . 120 N with the vehicle 110 can comprise controlling at least one vehicle function of the vehicle 110.

For this purpose, the vehicle 110 can comprise a control unit 114 configured to control or regulate a predefinable or predefined vehicle function according to the trigger event and/or the interaction between smart device 120 A . . . 120 N and vehicle 110, as explained further below with reference to a plurality of exemplary embodiment variants.

Advantageously, a particularly agile and flexible interaction between the smart device 120 A . . . 120 N, the vehicle 110 and also optionally further devices connected to the smart device 120 A . . . 120 N and/or the bearer of the smart device 120 A . . . 120 N can thus be effected. Advantageously, the agility and flexibility of the interaction between smart device 120 A . . . 120 N and vehicle 110 is thus increased. There is thus an increase in the agility and flexibility during the control of the vehicle functions, the security—through the use of digital key standards—in the interaction between smart device 120 A . . . 120 N and vehicle 110 and thus in the control of the vehicle functions being ensured at the same time.

Exemplary embodiments are explained below.

### Example 1: Interaction and Control of Vehicle Functions—Tire Pressure

A vehicle 110 comprises suitable sensors from the prior art which acquire sensor values with regard to the tire pressure of each of the tires of the vehicle. A smart device 120 A . . . 120 N is assigned to the user of the vehicle 110 and is coupled to the vehicle 110 by means of BLE.

A trigger event is predefined or predefinable as follows:

at least one tire pressure sensor determines at least one tire pressure that is not suitable for at least one tire of the vehicle 110; and

a current GPS position in combination with POI data reveals that the vehicle 110 is situated at a gas station or service station or a suitable location for checking a tire pressure; and

the vehicle 110 determines by way of BLE that the user or driver of the vehicle 110, who is the bearer of the smart device 120 A . . . 120 N, is moving out of the vehicle 110.

The vehicle 110 is configured to determine the abovementioned trigger event by means of evaluation of the corresponding sensor data (tire pressure sensor, position sensor, POI map data) and communicates a corresponding trigger data set to the smart device 120 A . . . 120 N. The trigger data set can comprise:

data with respect to the position of the tire(s) comprising a tire pressure that is not suitable for the tire(s) of the vehicle 110;

data with respect to a target tire pressure for the tire(s) determined above.

The smart device 120 A . . . 120 N receives the trigger data set and is configured to interact with the vehicle 110 according to the trigger data set. In particular, the interaction can comprise the following steps:

the trigger data set triggers an interaction application, which is loaded and executed on the smart device 120 A . . . 120 N. The interaction application triggers a notification via the smart device 120 A . . . 120 N in a manner known from the prior art and can comprise for example a haptic and/or visual and/or acoustic message to the user of the smart device 120 A . . . 120 N with the advice that the tire pressure can be checked or adjusted at the current geographical location (gas station, service station, etc.).

The user of the smart device 120 A . . . 120 N can indicate by means of an input (e.g. voice input and/or touch input) that the user will check the tire pressure;

the smart device 120 A . . . 120 N indicates the tire(s) for which the tire pressure needs to be checked (e.g. front left and back right);

the vehicle 110 determines—for example by means of UWB—the location at the vehicle 110 or the tire of the vehicle 110 at which the user of the vehicle 110 or the bearer of the smart device 120 A . . . 120 N is situated (spatial relation), or determines, on the basis of a movement vector of the user of the smart device 120 A . . . 120 N, the tire of the vehicle 110 to which the user is expected to move, and sends a message comprising relevant data (actual tire pressure and target tire pressure of the tire) to the smart device 120 A . . . 120 N, for example by means of BLE;

for this tire, the smart device 120 A . . . 120 N outputs the actual tire pressure determined by the tire pressure sensor and also the target tire pressure to the user of the vehicle 110;

the user of the vehicle 110 confirms by way of input via the smart device 120 A . . . 120 N that the user has checked and possibly correctly adjusted the tire pressure.

In another example, the tire inflater or the tire air pressure device can be a smart device. In this example, the smart device 120 A . . . 120 N receives the trigger data set and is configured to interact with the vehicle 110 according to the trigger data set. In particular, the interaction can comprise the following steps:

the trigger data set triggers an interaction application, which is loaded and executed on the smart device 120 A . . . 120 N. The interaction application triggers a notification via the smart device 120 A . . . 120 N in a manner known from the prior art and can comprise for example a haptic and/or visual and/or acoustic message to the user of the smart device 120 A . . . 120 N with the advice that the tire pressure can be checked or adjusted at the current geographical location by means of the smart device tire air pressure device (availability of smart device tire air pressure device at gas station, service station, etc.).

The user of the smart device 120 A . . . 120 N can indicate by means of an input (e.g. voice input and/or touch input) that the user will check the tire pressure;

the smart device 120 A . . . 120 N indicates the tire(s) for which the tire pressure needs to be checked (e.g. front left and back right);

the vehicle 110 determines—for example by means of UWB—the location at the vehicle 110 or the tire of the vehicle 110 at which the user of the vehicle 110 or the bearer of the smart device 120 A . . . 120 N is situated (spatial relation), or determines, on the basis of a movement vector of the user of the smart device 120 A . . . 120 N, the tire of the vehicle 110 to which the user is expected to move, and sends a message comprising relevant data (actual tire pressure and target tire pressure of the tire) to the smart device 120 A . . . 120 N, and also the target tire pressure of the tire directly or indirectly by means of the smart device 120 A . . . 120 N to the smart device tire air pressure device for example by means of BLE, WiFi or Thread;

the smart device tire air pressure device sets the received target tire pressure at the tire and reports back the status;

the user of the vehicle 110 confirms—optionally—by way of input via the smart device 120 A . . . 120 N that the user has checked the tire pressure set by the smart device tire air pressure device.

The interacting of the smart device 120 A . . . 120 N with the vehicle 110 subsequently comprises controlling a vehicle function (checking the tire pressure) of the vehicle 110:

the smart device 120 A . . . 120 N communicates a corresponding control message—for example via BLE—to the vehicle 110;

the vehicle 110—after receiving the control message—controls the tire pressure sensor in such a way that the latter checks the tire pressure newly set by the user of the vehicle 110, and sends a checking message (actual tire pressure now corresponds to target tire pressure, or actual tire pressure still does not correspond to the target tire pressure) to the smart device 120 A . . . 120 N;

the smart device 120 A . . . 120 N outputs (acoustically and/or visually) the checking message to the user of the vehicle 110.

If the user of the vehicle 110 and of the smart device 120 A . . . 120 N is situated at the tire, the user can also start a tire check via the smart device 120 A . . . 120 N. In this case, the smart device 120 A . . . 120 N can record an image of the tire by means of an integrated camera. By means of known image processing algorithms and also by means of suitable machine learning algorithms, it is possible—at the smart device 120 A . . . 120 N or after communication of the recorded image at the vehicle 110 or after communication to a backend—on the basis of textual identifications, QR codes, etc. at the tire—to determine whether the recorded tire is approved for the vehicle 110, corresponds to the safety specifications, is mounted correctly with regard to the direction of travel, etc.

The abovementioned steps can be repeated for possible further tires and/or a renewed difference between actual tire pressure and target tire pressure of the tire.

### Example 2: Interactive Setting of Vehicle Functions

A user of the vehicle 110 carries a smart device 120 A . . . 120 N, which is known to the vehicle 110 and is coupled to the latter (e.g. smart device 120 A . . . 120 N as digital key of the vehicle 110).

Predefined or predefinable trigger event:

identifying a preset presentation or greeting of the user of the vehicle 110 upon the user approaching the vehicle 100, if the user is carrying the smart device 120 A . . . 120 N (presetting of vehicle function in combination with user profile of smart device 120 A . . . 120 N). A presentation can comprise: switching on the low-beam light and/or switching on interior lighting of the vehicle 110 and/or outputting a sound presentation via vehicle loudspeakers and/or folding out the exterior mirrors of the vehicle etc. starting from when the smart device 120 A . . . 120 N is at a specific distance from the vehicle 110.

Recognizing that the vehicle 110 is being approached by the user carrying the smart device 120 A . . . 120 N (e.g. by means of UWB, spatial relation).

The vehicle 110 is configured to determine the abovementioned trigger event by means of evaluation of the corresponding sensor data (user profile data, UWB sensor system) and communicates a corresponding trigger data set to the smart device 120 A . . . 120 N. The trigger data set can comprise:

data with respect to starting the presentation according to the user profile.

The smart device 120 A . . . 120 N receives the trigger data set and is configured to interact with the vehicle 110 according to the trigger data set. In particular, the interaction can comprise the following steps:

the trigger data set triggers an interaction application, which is loaded and executed on the smart device 120 A . . . 120 N. The interaction application triggers a notification via the smart device 120 A . . . 120 N in a manner known from the prior art and can comprise for example a haptic and/or visual and/or acoustic message to the user of the smart device 120 A . . . 120 N with the advice that the presentation will be started according to the user profile and/or that the presentation will be started the next time the user of the vehicle 110 is predicted to depart (for example on the basis of a learning user profile).

The user of the smart device 120 A . . . 120 N can indicate by means of an input (e.g. voice input and/or touch input) that the user does not want a presentation according to the user profile for a next approach to the vehicle 110 and/or for a predetermined or predeterminable period of time;

The interacting of the smart device 120 A . . . 120 with the vehicle 110 subsequently comprises controlling a vehicle function (brief deactivation of the presentation according to the user profile) of the vehicle 110:

the smart device 120 A . . . 120 communicates a corresponding control message—for example via BLE—to the vehicle 110;

the vehicle 110—after receiving the control message—controls the vehicle functions according to the presentation in such a way that the vehicle 110 deactivates the presentation for the next approach to the vehicle 110 by the user, for the next approach and/or for the predefined or predefinable period of time, and communicates a success message (presentation is deactivated for the next approach to the vehicle 110 or the predefined or predefinable period of time) to the smart device 120 A . . . 120;

the smart device 120 A . . . 120 outputs (acoustically and/or visually) the checking message to the user of the vehicle 110.

Furthermore, by means of suitable machine learning algorithms, for example with the aid of models created by machine learning methods—e.g. by means of supervised learning or unsupervised learning—the vehicle 110 can learn at what times and/or at what geographical positions etc. the presentation is not necessary or has been deactivated by the user of the vehicle 110, and can automatically adopt this setting for the future.

A deactivation of the presentation may be desired by the user of the vehicle 110, for example, if:

the vehicle 110 is standing in a driveway of a house and the user—on account of working on the house and/or in the garden—frequently passes by the vehicle 110 without wanting to use the latter;

the presentation is intended not to occur on account of a relatively late time of day (light/noise nuisance);

the presentation is intended not to occur on account of an activity at a specific geographical position (e.g. observation of wildlife in a forest);

etc.

### Example 3: Personalization of Vehicle Functions

At least two users of the vehicle 110 are carrying a smart device 120 A . . . 120 N, which are known to the vehicle 110 and are coupled thereto (e.g. both smart devices 120 A . . . 120 N as a digital key of the vehicle 110).

Predefined or predefinable trigger event:

the at least two users approach the vehicle 110 in each case with the smart device 120 A . . . 120 N (digital key technology).

Each user or smart device 120 A . . . 120 N is assigned a user profile, wherein the user profile comprises vehicle settings such as e.g. seat setting, mirror setting, etc., which are automatically set by the vehicle 110.

The vehicle 110 cannot unambiguously recognize which user takes a seat at which position in the vehicle 110 or, with the aim of localizing the smart device 120 A . . . 120 N relative to the vehicle 110 or the movement trajectory of the approach to the vehicle 110, which user or which associated smart device 120 A . . . 120 N is moving to which position in the vehicle 110.

The vehicle 110 is configured to determine the abovementioned trigger event by means of evaluation of the corresponding sensor data (interior sensor system, position sensor, POI map data) and communicates a corresponding trigger data set to the smart devices 120 A . . . 120 N of the at least two users. The trigger data set can comprise:

data with respect to the recognition of at least two smart devices 120 A . . . 120 N.

Each smart device 120 A . . . 120 N receives the trigger data set and is configured to interact with the vehicle 110 according to the trigger data set. In particular, the interaction can comprise the following steps:

the trigger data set triggers an interaction application, which is loaded and executed on the smart device 120 A . . . 120 N. The interaction application triggers a notification via the smart device 120 A . . . 120 N in a manner known from the prior art and can comprise for example a haptic and/or visual and/or acoustic message to the user of the smart device 120 A . . . 120 N with the advice that the presence of at least two users has been recognized.

The user of the smart device 120 A . . . 120 N can indicate by means of an input (e.g. voice input and/or touch input) the position in the vehicle 110 at which the user takes a seat (driver, passenger, back seat right, back seat middle, back seat left, etc.).

The interacting of the smart devices 120 A . . . 120 with the vehicle 110 subsequently comprises controlling a vehicle function (vehicle settings according to the user profile of the respective smart device 120 A . . . 120 N) of the vehicle 110:

each smart device 120 A . . . 120 communicates a corresponding control message—for example via BLE—to the vehicle 110;

the vehicle 110—after receiving the control message—controls the vehicle functions in such a way that the latter are set according to the position in the vehicle 110, and communicates a success message to the respective smart device 120 A . . . 120 N;

the smart device 120 A . . . 120 outputs (acoustically and/or visually) the checking message to the respective bearers thereof.

### Example 4: Interactive Control of Anti-Theft Warning Systems in Conjunction with Presence Recognition of Person and/or Animal in the Vehicle 110

A user of the vehicle 110 is carrying a smart device 120 A . . . 120 N, which is known to the vehicle 110 and is coupled thereto (e.g. smart device 120 A . . . 120 N as digital key of the vehicle 110).

Predefined or predefinable trigger event:

a current GPS position in combination with POI data reveals that the vehicle 110 is situated at a gas station or service station.

The user of the vehicle 110 leaves the vehicle 110 (determination for example by way of UWB).

A person, e.g. the passenger, or an animal remains in the vehicle 110 (determination for example by way of interior camera and/or seat occupancy mat with a corresponding sensor system, etc.).

The vehicle 110 is configured to determine the abovementioned trigger event by means of evaluation of the corresponding sensor data (interior sensor system, position sensor, POI map data) and communicates a corresponding trigger data set to the smart device 120 A . . . 120 N. The trigger data set can comprise:

data with respect to the recognition of a remaining person and/or a remaining animal in the vehicle;

data with respect to the vehicle function of the anti-theft warning system, which is activated by the vehicle 110 being left by the vehicle user (and thus attendant locking of the vehicle 110).

The smart device 120 A . . . 120 N receives the trigger data set and is configured to interact with the vehicle 110 according to the trigger data set. In particular, the interaction can comprise the following steps:

the trigger data set triggers an interaction application, which is loaded and executed on the smart device 120 A . . . 120 N. The interaction application triggers a notification via the smart device 120 A . . . 120 N in a manner known from the prior art and can comprise for example a haptic and/or visual and/or acoustic message to the user of the smart device 120 A . . . 120 N with the advice that there is still a person or an animal in the vehicle 110 and/or the anti-theft warning system is activated as a result of the vehicle 110 being left and there is thus the risk of the anti-theft warning system being activated by movement in the vehicle interior.

The user of the smart device 120 A . . . 120 N can indicate by means of an input (e.g. voice input and/or touch input) that the anti-theft warning system is intended to be deactivated for a predetermined or predeterminable period of time (e.g. for 5 minutes, for 10 minutes, until the return of the user and thus until the next time the vehicle 110 is unlocked), wherein the predetermined or predeterminable period of time can be fixedly predefined or can be selected by the user of the smart device 120 A . . . 120 N or of the vehicle 110 by way of input;

The interacting of the smart device 120 A . . . 120 with the vehicle 110 subsequently comprises controlling a vehicle function (brief deactivation of the anti-theft warning system) of the vehicle 110:

the smart device 120 A . . . 120 communicates a corresponding control message—for example via BLE—to the vehicle 110;

the vehicle 110—after receiving the control message—controls the anti-theft warning system in such a way that the vehicle 110 deactivates the anti-theft warning system for the predefined or predefinable period of time and communicates a success message (anti-theft warning system is deactivated for the predefined or predefinable period of time) to the smart device 120 A . . . 120;

the smart device 120 A . . . 120 outputs (acoustically and/or visually) the checking message to the user of the vehicle 110.

### Example 5: Linking Smart Home Functions to Vehicle 110

There currently exist IP-based connectivity standards (e.g. Matter) for the automation of home functions (smart home devices). All smart home devices which support this standard are thereby enabled to communicate. In particular, the smart device 120 A . . . 120 N can thus control smart home devices by means of a smart device application by way of the IP-based connectivity standards.

A user of the vehicle 110 is carrying a smart device 120 A . . . 120 N, which is known to the vehicle 110 and is coupled thereto (e.g. smart device 120 A . . . 120 N as digital key of the vehicle 110). A smart device application is loaded on the smart device 120 A . . . 120 N and can be executed on the latter, which application can control smart home devices of an associated smart home by way of an IP-based connectivity standard. A list of the smart home devices which are controlled by the smart device 120 A . . . 120 N is stored on the smart device 120 A . . . 120 N and is synchronized with the vehicle. The synchronization can be effected by way of a backend, for example. In this case, a corresponding device identification with parameters such as e.g. device type, device designation, GPS position of the device (e.g. garage with smart home garage opener) is stored for each smart home device.

Predefined or predefinable trigger event:

a current GPS position and/or a journey route input in the vehicle 110 reveals that the vehicle 110 is approaching a position at which a smart home device which can be controlled by the smart device 120 A . . . 120 N is situated. The smart home device is known to the vehicle 110. This can arise for example from the abovementioned synchronization of the list with the vehicle 110.

The vehicle 110 recognizes that the list of the smart home devices at the current GPS position includes a garage with a smart home garage door.

The vehicle 110 signals and/or displays to the user, for example via a suitable output unit, the smart home devices available at the position determined.

The user of the vehicle 110 and of the smart device 120 A . . . 120 N can input by means of an input (e.g. voice input and/or touch input) in the vehicle 110 the intended operational control of the available smart home device(s) or the intended querying of a status. By way of example, the user of the vehicle sees that the garage with the smart home garage door is closed (status query), and can input the intended opening thereof (operational control). The vehicle communicates the user's input (status query and/or operational control) to the smart device 120 A . . . 120 N. The smart device 120 A . . . 120 N controls the smart home garage door according to the communicated input from the user.

The vehicle 110 communicates a corresponding trigger data set calculated from the communicated input from the user to the smart device 120 A . . . 120 N. The trigger data set can comprise:

data with respect to the recognition of an approach to the garage with the smart home garage door;

smart home device type, designation and identification number, which can be uniquely assigned to the smart home device list present in the smart device;

a control command, e.g. garage opened/closed, luminaire brightness 0-100%, etc.

The smart device 120 A . . . 120 N receives the trigger data set and is configured to interact with the vehicle 110 according to the trigger data set. In particular, the interaction can comprise the following steps:

the trigger data set triggers an interaction between smart device 120 A . . . 120 N and vehicle 110;

the smart device 120 A . . . 120 controls the smart home garage door according to the control message in an IP-based manner (e.g. Matter) by initiating the opening of the garage door. The interaction can comprise a feedback message from the smart device 120 A . . . 120 N to the vehicle 110 regarding successful performance of the action, for example the garage is open. The feedback message can be output in the vehicle 110 to the user of the vehicle 110 via a suitable output unit.

Advantageously, it is thus possible to realize—in an analogous manner—any desired smart home functions as extended vehicle functions by way of the smart device 120 A . . . 120 N.

In particular, it is thus possible to carry out—analogously to the procedure above—the control of a multiplicity of smart home devices, for example the control of smart home lighting in the garage or in the driveway of the house of the user of the vehicle 110. Furthermore, on account of the bidirectional communication between smart device 120 A . . . 120 N and vehicle 110 (as an example of the interaction between smart device 120 A . . . 120 N), it is possible to indicate statuses of smart home devices in the vehicle 110, e.g. “garage is open”.

### Example 6: Control of Arbitrary Vehicle Functions or Vehicle Settings in the Vehicle 110

A user of the vehicle 110 is carrying a smart device 120 A . . . 120 N which couples to the vehicle 110. The smart device 120 A . . . 120 N comprises a digital key for the use of the vehicle 110. The vehicle 110 recognizes that the user is an occasional user of the vehicle 110 (e.g. car sharing use, taxi journey, etc.).

Predefined or predefinable trigger event:

the vehicle 110, with the aid of the digital key, recognizes that the user of the smart device 120 A . . . 120 N is an occasional user or one-off user of the vehicle 110 and where this user is situated in the vehicle 110.

The vehicle 110 is configured to determine the abovementioned trigger event by means of evaluation of the corresponding sensor data (interior sensor system, UWB sensor system, digital key standard) and communicates a corresponding trigger data set to the smart device 120 A . . . 120 N. The trigger data set can comprise:

data with respect to possibilities of vehicle settings in the vehicle 110 or at the position in the vehicle 110 (spatial relation). These can comprise for example setting possibilities at the seat, travel data or navigation data etc.

The smart device 120 A . . . 120 N receives the trigger data set and is configured to interact with the vehicle 110 according to the trigger data set. In particular, the interaction can comprise the following steps:

the trigger data set triggers an interaction application, which is loaded and executed on the smart device 120 A . . . 120 N. The interaction application triggers a notification via the smart device 120 A . . . 120 N in a manner known from the prior art and can comprise for example a haptic and/or visual and/or acoustic message to the user of the smart device 120 A . . . 120 N with advice about possible vehicle settings.

The user of the smart device 120 A . . . 120 N can indicate by means of an input (e.g. voice input and/or touch input) the intention to carry out specific vehicle settings.

The interacting of the smart device 120 A . . . 120 with the vehicle 110 subsequently comprises controlling a vehicle function (setting the vehicle functions) of the vehicle 110:

the smart device 120 A . . . 120 communicates a corresponding control message—for example via BLE—to the vehicle 110;

the vehicle 110—after receiving the control message—controls the vehicle settings according to the control message and communicates a success message (vehicle settings have been implemented) to the smart device 120 A . . . 120;

the smart device 120 A . . . 120 outputs (acoustically and/or visually) the checking message to the user of the vehicle 110.

### Example 7: Transfer of Telephony and/or Entertainment Functions

At least one user of the vehicle 110 is carrying a smart device 120 A . . . 120 N, which is known to the vehicle 110 and is coupled thereto (e.g. smart device 120 A . . . 120 N as digital key of the vehicle 110).

Predefined or predefinable trigger event:

the vehicle 110 recognizes that the user of the vehicle 110 and user of the smart device 120 A . . . 120 N is getting into the vehicle 110 or leaving the vehicle 110 (e.g. UWB sensor system, vehicle interior sensors).

The vehicle 110 recognizes an ongoing telephony and/or entertainment function on the smart device 120 A . . . 120 N).

The vehicle 110 is configured to determine the abovementioned trigger event by means of evaluation of the corresponding sensor data (interior sensor system, UWB sensor system) and communicates a corresponding trigger data set to the smart device 120 A . . . 120 N. The trigger data set can comprise:

data with respect to the recognition of the user getting into or out of the vehicle 110.

The smart device 120 A . . . 120 N receives the trigger data set and is configured to interact with the vehicle 110 according to the trigger data set. In particular, the interaction can comprise the following steps:

the trigger data set triggers an interaction application, which is loaded and executed on the smart device 120 A . . . 120 N.

The interacting of the smart device 120 A . . . 120 with the vehicle 110 subsequently comprises controlling a vehicle function (e.g. transferring the audio stream of a telephony function implemented via the smart device 120 A . . . 120 N from the vehicle to the smart device 120 A . . . 120 N; and/or transferring the telephony function (e.g. in the case of Voice over IP telephony) and/or entertainment function of the smart device 120 A . . . 120 N into the vehicle 110 or from the vehicle 110 into the smart device 120 A . . . 120 N of the vehicle 110:

the vehicle 110 recognizes that the user is getting out of the vehicle 110. After the actuation of the door contact of the vehicle 110 has been recognized, the ongoing telephony function (Voice over IP) or the ongoing audio stream of a telephone call conducted via the smart device 120 A . . . 120 N is transferred from the vehicle 110 to the smart device 120 A . . . 120 N in a manner known from the prior art; or

the vehicle 110 recognizes that the user is getting into the vehicle 110. After the actuation of the door contact has been recognized, an ongoing entertainment function (e.g. video streaming) is transferred from the smart device 120 A . . . 120 N via the corresponding output unit at the position in the vehicle 110 at which the user takes a seat (spatial relation), in a manner known from the prior art, and continues to be implemented. In the case of video streaming, here the video can continue to be implemented on the smart device 120 A . . . 120 N and the audio and video output can be effected via suitable output units in the vehicle 110. As an alternative thereto, the smart device 120 A . . . 120 N can communicate to the vehicle 110—if the latter has an integrated SIM card—a URL and a current time or time stamp of the video, such that the latter is transmitted via the vehicle.

### Example 8: Warning about Forgotten Objects in the Vehicle 110

It is known from the prior art to attach a locating device or tracker to an object, which makes it possible to find the object by way of radio technology, e.g. UWB or BLE, for example Apple AirTag.

A user of the vehicle 110 is carrying a smart device 120 A . . . 120 N, which is known to the vehicle 110 and is coupled thereto (e.g. smart device 120 A . . . 120 N as digital key of the vehicle 110). A locating device is attached at least to one object, for example an umbrella, and is known to the vehicle 110 and/or smart device 120 A . . . 120 N.

Predefined or predefinable trigger event:

the vehicle 110 recognizes that the user of the vehicle 110 is leaving the vehicle 110.

the vehicle 110 recognizes that the umbrella has been left behind in the vehicle 110.

the vehicle 110 recognizes that it will rain. Alternatively, by means of corresponding machine learning algorithms, the vehicle 110 can recognize that the user of the vehicle 110 always takes the umbrella with them.

The vehicle 110 is configured to determine the abovementioned trigger event by means of evaluation of the corresponding sensor data (BLE sensor system, UWB sensor system, integrated weather application in the vehicle) and communicates a corresponding trigger data set to the smart device 120 A . . . 120 N. The trigger data set can comprise:

data with respect to the object left behind in the vehicle 110;

data with respect to the weather situation (it is supposed to rain) or data with respect to past habits of the user (the umbrella is always taken along).

The smart device 120 A . . . 120 N receives the trigger data set and is configured to interact with the vehicle 110 according to the trigger data set. In particular, the interaction can comprise the following steps:

the trigger data set triggers an interaction application, which is loaded and executed on the smart device 120 A . . . 120 N. The interaction application triggers a notification via the smart device 120 A . . . 120 N in a manner known from the prior art and can comprise for example a haptic and/or visual and/or acoustic message to the user of the smart device 120 A . . . 120 N with the advice that the umbrella has been left behind in the vehicle and it is supposed to rain or the umbrella is always taken along.

The example mentioned above can be extended or supplemented in any desired way—for example with the aid of suitable machine learning algorithms. By way of example, the vehicle 110 and/or the smart device 120 A . . . 120 N can “learn” that the user of the vehicle 110 does not want a notification upon leaving the umbrella behind in the vehicle 110—despite predicted rainy weather—if the vehicle is parked in its own garage, since in this case of use the user of the vehicle 110 will always leave the umbrella behind in the vehicle. In addition or as an alternative thereto, the smart device 120 A . . . 120 N can also warn against forgetting the umbrella if the latter is not situated in the vehicle, e.g. is forgotten after a restaurant visit in a restaurants.

### Example 8: Reminder to Carry Out Vehicle-Related Actions

A user of the vehicle 110 is carrying a smart device 120 A . . . 120 N, which is known to the vehicle 110 and is coupled thereto (e.g. smart device 120 A . . . 120 N as digital key of the vehicle 110).

Predefined or predefinable trigger event:

the vehicle 110 recognizes that the user of the vehicle 110 is leaving the vehicle 110.

the vehicle 110 recognizes that a vehicle-related action must be carried out;

the vehicle 110 determines from a geographical position in combination with POI map data that the vehicle-related action can be carried out at the current geographical position.

The vehicle 110 is configured to determine the abovementioned trigger event by means of the evaluation of the corresponding sensor data (BLE sensor system, UWB sensor system, integrated vehicle sensors, GPS sensor) and communicates a corresponding trigger data set to the smart device 120 A . . . 120 N. The trigger data set can comprise:

data with respect to the vehicle function to be carried out, e.g. wiping water in the vehicle empty, state of charge of an electrical energy store or tank filling level low, optionally in regard to the distance of the next journey predicted to be travelled, etc.

The smart device 120 A . . . 120 N receives the trigger data set and is configured to interact with the vehicle 110 according to the trigger data set. In particular, the interaction can comprise the following steps:

the trigger data set triggers an interaction application, which is loaded and executed on the smart device 120 A . . . 120 N. The interaction application triggers a notification via the smart device 120 A . . . 120 N in a manner known from the prior art and can comprise for example a haptic and/or visual and/or acoustic message to the user of the smart device 120 A . . . 120 N with the advice that the vehicle-related action determined can be carried out.

### Example 9: Activation of Social Network Applications

A user of the vehicle 110 is carrying a smart device 120 A . . . 120 N, which is known to the vehicle 110 and is coupled thereto (e.g. smart device 120 A . . . 120 N as digital key of the vehicle 110).

Predefined or predefinable trigger event:

the vehicle 110 recognizes by means of suitable machine learning algorithms and/or on the basis of database entries, for example, that the vehicle 110 is situated at a popular geographical position or a special geographical position.

The vehicle 110 is configured to determine the abovementioned trigger event by means of evaluation of the corresponding sensor data (BLE sensor system, UWB sensor system, integrated vehicle sensors, GPS sensor) and communicates a corresponding trigger data set to the smart device 120 A . . . 120 N. The trigger data set can comprise:

data with respect to the popular or special geographical position.

The smart device 120 A . . . 120 N receives the trigger data set and is configured to interact with the vehicle 110 according to the trigger data set. The trigger data set triggers an interaction application, which is loaded and executed on the smart device 120 A . . . 120 N. The interaction application triggers a notification via the smart device 120 A . . . 120 N in a manner known from the prior art and can comprise for example a haptic and/or visual and/or acoustic message to the user of the smart device 120 A . . . 120 N with the advice that the vehicle is situated at a popular or special geographical position.

The user of the smart device 120 A . . . 120 N can indicate by means of an input (e.g. voice input and/or touch input) that the user wants to record the popular or special geographical position or a recorded data set is available in the temporary memory.

The interacting of the smart device 120 A . . . 120 with the vehicle 110 subsequently comprises controlling a vehicle function (recording the popular or special geographical position) of the vehicle 110:

the smart device 120 A . . . 120 communicates a corresponding control message—for example via BLE—to the vehicle 110;

the vehicle 110—after receiving the control message—controls exterior cameras of the vehicle 110 in such a way that the popular or special geographical position is photographed or recorded. The vehicle 110 communicates a success message (comprising the photographed or recorded geographical position) to the smart device 120 A . . . 120;

the smart device 120 A . . . 120 outputs (acoustically and/or visually) the checking message to the user of the vehicle 110, such that the user of the smart device can upload the photograph or the recording via a social media application.

### Example 10: Complying with Parking or Waiting Regulations

A user of the vehicle 110 is carrying a smart device 120 A . . . 120 N, which is known to the vehicle 110 and is coupled thereto (e.g. smart device 120 A . . . 120 N as digital key of the vehicle 110).

Predefined or predefinable trigger event:

the vehicle 110 recognizes that a parking or waiting process is under way; and

the vehicle 110 recognizes that parking/waiting regulations are in force.

In this case, it is possible to predefine for example that a vehicle 110 is waiting if the user of the vehicle 110 remains in the vehicle 110 and does not wait for longer than 3 minutes, and a vehicle 110 is parked if the user of the vehicle 110 leaves the vehicle 110 or waits for longer than 3 minutes. Different parking or waiting regulations may be in force for the parking or waiting of the vehicle 110.

The vehicle 110 is configured to determine the abovementioned trigger event by means of evaluation of the corresponding sensor data (BLE sensor system, UWB sensor system, GPS position or geographical position of the vehicle, navigation data of the vehicle, database entries concerning parking regulations at the current GPS position, evaluation of traffic signs captured by vehicle cameras) and communicates a corresponding trigger data set to a smart device 120 A . . . 120 N. The trigger data set can comprise:

data with respect to waiting/parking regulations currently in force at the current geographical position (e.g. waiting/parking only for a limited time, ticket required for authorizing parking, etc.).

The smart device 120 A . . . 120 N receives the trigger data set. The trigger data set triggers an interaction application, which is loaded and executed on the smart device 120 A . . . 120 N. The interaction application triggers a notification via the smart device 120 A . . . 120 N in a manner known from the prior art and can comprise for example a haptic and/or visual and/or acoustic message to the user of the smart device 120 A . . . 120 N with advice about parking regulations currently in force. The user of the smart device 120 A . . . 120 N can indicate by means of an input (e.g. voice input and/or touch input) that the user no longer wants advice in future for the current geographical position. This input is communicated from the smart device 120 A . . . 120 N to the vehicle 110 and correspondingly stored in a storage unit.

The examples mentioned above are exemplary embodiments and serve for elucidation. The trigger events and also the interactions between smart device 120 A . . . 120 N and vehicle 110 can be arbitrarily combined and extended.

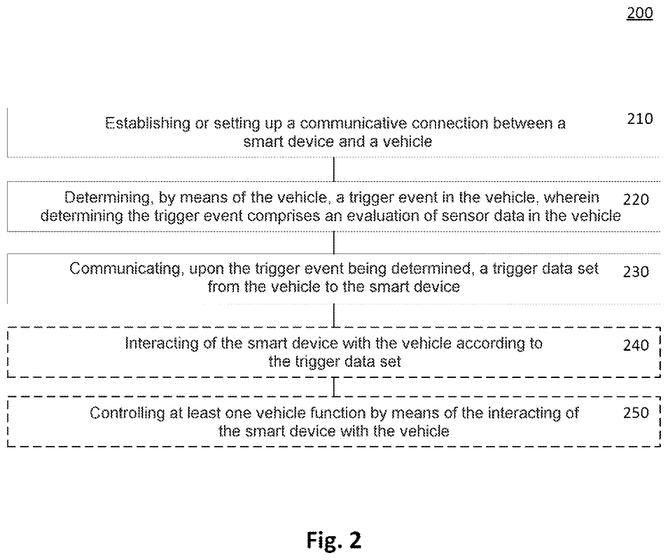

FIG. 2 shows a method 200 for the interactive control of vehicle functions of a vehicle 110, which method can be carried out by a system 100 as described with reference to FIG. 1.

The method 200 comprises:

establishing 210 a communicative connection between a smart device 120 A . . . 120 N and a vehicle 110;

determining 220, by means of the vehicle 110, a trigger event in the vehicle 110, wherein determining the trigger event comprises an evaluation of sensor data in the vehicle 110;

communicating 230, upon the trigger event being determined, a trigger data set to the smart device 120 A . . . 120 N;

interacting 240 of the smart device 120 A . . . 120 N with the vehicle 110 according to the trigger data set.

The interacting 240 of the smart device 120 A . . . 120 N with the vehicle 110 can comprise controlling at least one vehicle function of the vehicle 110.

The vehicle 110 and the smart device 120 A . . . 120 N can each comprise a communication unit 116, 126, wherein the communicative connection between vehicle 110 and smart device 120 comprises a Bluetooth Low Energy, BLE, connection.

The evaluating of sensor data in the vehicle 110 when determining the trigger event can comprise determining a spatial relation between the smart device 120 A . . . 120 N and the vehicle 110.

The sensor data in the vehicle 110 which are evaluated for determining the trigger event in the vehicle can comprise:
a current geographical position of the vehicle 110; and/or
data concerning a Point of Interest, POI, according to a current geographical position of the vehicle 110; and/or
data with respect to a geographical position that is important for the user of the vehicle 110; and/or
a current time of day or a current time stamp; and/or
a current position and/or a current movement vector of the smart device 120 A . . . 120 N relative to the vehicle 110; and/or
a current state of a vehicle function or a current vehicle sensor value, wherein the vehicle function or the vehicle sensor value can comprise data with respect to the following vehicle functions or vehicle sensor values:
   light switched on or off; and/or
   doors right/left front/back or trunk or hood opened or closed; and/or
   current tire pressure of tires front/back right/left; and/or
   charging flap and/or gas cap opened/closed; and/or
   requisite need for maintenance in the vehicle; and/or
   state of charge or fuel tank level of the vehicle; and/or
   any further suitable current state of a vehicle function or vehicle sensor value.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for interaction control of vehicle functions, comprising:
a vehicle; and
a smart device configured to establish a communicative connection with the vehicle;
wherein the vehicle is configured to:
determine a trigger event in the vehicle comprising an evaluation of sensor data in the vehicle; and
communicate a trigger data set to the smart device upon the trigger event being determined; and
wherein the smart device is configured to, after receiving the trigger data set, interact with the vehicle according to the trigger data set.

2. The system according to claim 1, wherein the smart device is configured to interact with the vehicle by controlling at least one vehicle function of the vehicle.

3. The system according to claim 1, wherein the vehicle comprises a vehicle communication unit and the smart device comprises a smart device communication unit, and wherein the communicative connection between vehicle and smart device comprises a Bluetooth Low Energy (BLE) connection.

4. The system according to claim 1, wherein the vehicle is further configured to determine the trigger event comprising the evaluation of the sensor data in the vehicle further comprising determining a spatial relation between the smart device and the vehicle.

5. The system according to claim 1, wherein the sensor data in the vehicle comprise at least one of the following:
a current geographical position of the vehicle; /or
data concerning a Point of Interest, POI, according to a current geographical position of the vehicle;
data with respect to a geographical position that is important for the user of the vehicle;
a current time of day or a current time stamp;
a current position and/or a current movement vector of the smart device relative to the vehicle; and/or
a current state of a vehicle function or a current vehicle sensor value.

6. The system according to claim 1, wherein the sensor data in the vehicle comprises a current state of a vehicle function or a current vehicle sensor value, wherein the vehicle function or the current vehicle sensor value comprises data with respect to at least one of the following vehicle functions or vehicle sensor values:
light switched on or off;
doors right/left front/back or trunk or hood opened or closed;
current tire pressure of tires front/back right/left;
charging flap and/or gas cap opened/closed;
requisite need for maintenance in the vehicle; and/or
state of charge or fuel tank level of the vehicle.

7. A method for interactive control of vehicle functions, the method comprising:
establishing a communicative connection between a smart device and a vehicle;
determining, by the vehicle, a trigger event in the vehicle comprising evaluating sensor data in the vehicle;
communicating, in response to determining the trigger, a trigger data set to the smart device; and
interacting, by the smart device, with the vehicle according to the trigger data set.

8. The method according to claim 7, wherein interacting by the smart device with the vehicle comprises controlling at least one vehicle function of the vehicle.

9. The method according to claim 7, wherein establishing the communicative connection between the vehicle and the smart device comprises establishing a Bluetooth Low Energy (BLE) connection.

10. The method according to claim 7, wherein evaluating the sensor data in the vehicle comprises determining a spatial relation between the smart device and the vehicle.

11. The method according to claim 7, wherein evaluating the sensor data in the vehicle further comprises evaluating at least one of:
a current geographical position of the vehicle;
data concerning a Point of Interest, POI, according to a current geographical position of the vehicle;
data with respect to a geographical position that is important for the user of the vehicle;
a current time of day or a current time stamp;
a current position and/or a current movement vector of the smart device relative to the vehicle; and/or
a current state of a vehicle function or a current vehicle sensor value.

12. The method according to claim 7, wherein evaluating the sensor data in the vehicle further comprises evaluating a current state of a vehicle function or a current vehicle sensor value, wherein the vehicle function or the current vehicle sensor value can comprise data with respect to at least one of the following vehicle functions or vehicle sensor values:
light switched on or off;
doors right/left front/back or trunk or hood opened or closed;
current tire pressure of tires front/back right/left;
charging flap and/or gas cap opened/closed;
requisite need for maintenance in the vehicle; and/or
state of charge or fuel tank level of the vehicle.
